(19) United States
(12) Patent Application Publication
(10) Pub. No.: US 2023/0088736 A1
(43) Pub. Date: Mar. 23, 2023

(54) ELECTROLYSIS VESSEL

(71) Applicant: TOKUYAMA CORPORATION, Shunan-shi, Yamaguchi (JP)

(72) Inventor: Yasuyuki TANAKA, Shunan-shi (JP)

(73) Assignee: TOKUYAMA CORPORATION, Shunan-shi, Yamaguchi (JP)

(21) Appl. No.: 17/799,828

(22) PCT Filed: Mar. 23, 2021
(86) PCT No.: PCT/JP2021/011896

§ 371 Date: Aug. 15, 2022

(30) Foreign Application Priority Data
Mar. 31, 2020 (JP) 2020-062468

(51) Int. Cl. C25B 9/63; C25B 1/04; C25B 9/23

(52) U.S. Cl. CPC C25B 9/63; C25B 1/04; C25B 9/23

(57) ABSTRACT

An alkaline water electrolysis vessel including: a first frame body defining an anode chamber and including an electroconductive first separating wall and a first flange part; a second frame body defining a cathode chamber and including an electroconductive second separating wall and a second flange part; an ion-permeable separating membrane being arranged between the first frame body and the second frame body, and separating the anode chamber and the cathode chamber; an anode being arranged in the anode chamber, and being electrically connected with the first separating wall; and a cathode being arranged in the cathode chamber, and being electrically connected with the second separating wall, the first frame body further including: a nickel-plating layer of no less than 40 µm in thickness, and being arranged at least on a wet part of a first surface of the first frame body which faces the anode chamber.

### TECHNICAL FIELD

The present invention relates to an electrolysis vessel for alkaline water electrolysis.

### BACKGROUND ART

The alkaline water electrolysis method is known as a method of producing hydrogen gas and oxygen gas. In the alkaline water electrolysis method, hydrogen gas is generated at a cathode and oxygen gas is generated at an anode by electrolyzing water with a basic solution (alkaline water) as an electrolytic solution: in the basic solution, an alkali metal hydroxide (such as NaOH and KOH) dissolves. An electrolysis vessel including an anode chamber and a cathode chamber is known as an electrolysis vessel for alkaline water electrolysis: in the anode chamber, an anode is disposed, in the cathode chamber, a cathode is disposed, and the anode chamber and the cathode chamber are separated by an ion-permeable separating membrane. Generally, the electrolytes in the anode chamber and the cathode chamber of the alkaline water electrolysis vessel are alkaline, each having a pH of 12 or more (at 25° C.).

### CITATION LIST

### Patent Literature

Patent Literature 1: WO 2013/191140 A1

Patent Literature 2: JP 2016-094650 A

Patent Literature 3: JP S57-137486 A

### SUMMARY OF INVENTION

### Technical Problem

Patent Literature 1 discloses: “a bipolar alkaline water electrolysis unit included in an electrolytic cell adapted to electrolyze an electrolytic solution of alkaline water to obtain oxygen and hydrogen, the bipolar alkaline water electrolysis unit characterized in comprising an oxygen generating anode of a porous medium, a hydrogen generating cathode, a electroconductive partition wall that separates the anode and the cathode from each other, and an outer frame that surrounds the electroconductive partition wall, wherein a gas and electrolytic solution passage is provided at an upper portion of the electroconductive partition wall and/or the outer frame, and an electrolytic solution passage is provided at a lower part of the electroconductive partition wall and/or the outer frame”; that an electroconductive metal is used as the material of the partition wall; and nickeled mild steel, nickeled stainless steel, and nickel as electroconductive metallic materials that may be used for the partition wall.

Nickel is more expensive than ferrous material such as mild steel and stainless steel but has high electroconductivity. Thus, it is considered that the bipolar alkaline water electrolysis unit comprising a partition wall of nickeled mild steel can reduce energy loss because of its high electroconductivity. In view of improving the electroconductivity of the ferrous material, the thickness of the nickel-plating layer is sufficient if 2 to 30 µm. Providing a nickel-plating layer thicker than this range does not affect the electroconductivity.

In a conventional chloralkali electrolysis vessel, an alkaline electrolyte is supplied only to the cathode chamber, and an acid electrolyte is supplied to the anode chamber. Therefor, nickel is used for the cathode chamber in view of corrosion resistance in an alkaline condition and in view of processability; meanwhile, titanium is generally used for the anode chamber in view of corrosion resistance in an acid condition. In contrast, in the alkaline water electrolysis vessel, alkaline water as an electrolyte is supplied to both the anode chamber and the cathode chamber. Therefor, not only the cathode chamber but also the anode chamber is necessary to have corrosion resistance in an alkaline condition.

It cannot be said, however, that the corrosion resistance of the anode chamber in the alkaline water electrolysis vessel has been fully examined. In particular, while gas generated in the cathode chamber of the alkaline water electrolysis vessel is hydrogen gas, and the cathode chamber is filled with a reductive atmosphere; gas generated in the anode chamber thereof is oxygen gas, and the anode chamber is filled with an oxidizing atmosphere and the oxygen gas at the saturation level also dissolves in the anolyte. Therefore, it is considered that the corrosion resistance of the anode chamber of the alkaline water electrolysis vessel cannot be said to be sufficient for long-term use if this corrosion resistance is just enough to stand the alkaline condition in the cathode chamber.

An object of the present invention is to provide an alkaline water electrolysis vessel that enables the corrosion resistance of the anode chamber to the oxygen gas atmosphere and in oxygen gas-saturated alkaline water to be increased to a level sufficient for long-term use at low cost.

### Solution to Problem

The present invention encompasses the following embodiments [1] to [4].

An alkaline water electrolysis vessel comprising:
a first frame body defining an anode chamber,
the first frame body comprising:
   an electroconductive first separating wall; and
   a first flange part arranged at an outer periphery of the first separating wall;
a second frame body defining a cathode chamber,
the second frame body comprising:
   an electroconductive second separating wall; and
   a second flange part arranged at an outer periphery of the second separating wall;
an ion-permeable separating membrane being arranged between the first frame body and the second frame body, and separating the anode chamber and the cathode chamber;
an anode being arranged in the anode chamber, and being electrically connected with the first separating wall; and
a cathode being arranged in the cathode chamber, and being electrically connected with the second separating wall,
the first frame body further comprising:
   a nickel-plating layer of no less than 40 µm in thickness, the nickel-plating layer being arranged at least on a wet part of a first surface of the first frame body, the first surface facing the anode chamber.

[2] The electrolysis vessel according to [1],
the first frame body further comprising:
   an electroconductive supporting member protruding from the first separating wall into the anode chamber, and supporting the anode.

[3] The electrolysis vessel according to [1] or [2],
the first frame body comprising:
   at least one steel core member; and
   the nickel-plating member arranged on a surface of the core member.

[4] The electrolysis vessel according to any one of [1] to [3], wherein the nickel-plating layer has a thickness of 40 to 100 µm.

### Advantageous Effects of Invention

According to the alkaline water electrolysis vessel of the present invention, a nickel-plating layer of no less than 40 µm in thickness is arranged at least on a wet part of the first surface of the first frame body, the first surface facing the anode chamber, which enables the corrosion resistance of the anode chamber to the oxygen gas atmosphere and in oxygen gas-saturated alkaline water to be increased to a level sufficient for long-term use at low cost.

### BRIEF DESCRIPTION OF DRAWINGS

FIG. 1 is a cross-sectional view schematically illustrating an electrolysis vessel 100 according to one embodiment of the present invention; and

FIG. 2 is a cross-sectional view schematically illustrating an electrolysis vessel 200 according to another embodiment of the present invention.

### DESCRIPTION OF EMBODIMENTS

Hereinafter embodiments according to the present invention will be described with reference to the drawings. The present invention is not limited to these embodiments. The dimensions in the drawings do not always represent exact dimensions. Some reference signs may be omitted in the drawings. In the present description, the expression “A to B” concerning numeral values A and B shall mean “no less than A and no more than B” unless otherwise specified. In such an expression, if a unit is added only to the numeral value B, this unit shall be applied to the numeral value A as well. A word “or” shall mean a logical sum unless otherwise specified.

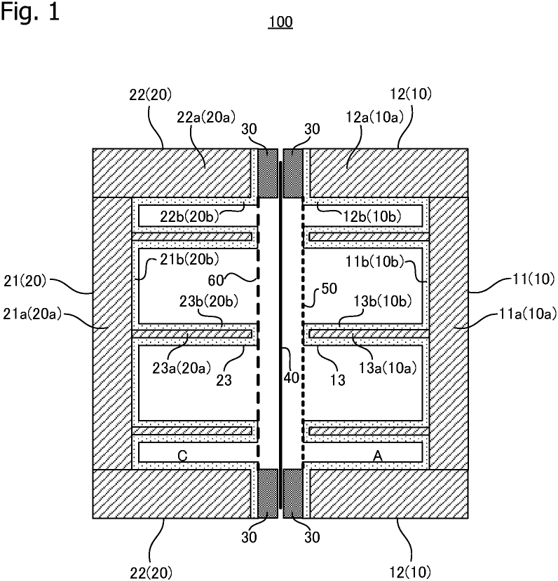

FIG. 1 is a cross-sectional view schematically illustrating an electrolysis vessel 100 according to one embodiment of the present invention. The electrolysis vessel 100 is an electrolysis vessel for alkaline water electrolysis. As shown in FIG. 1, the electrolysis vessel 100 comprises: a first frame body 10 defining an anode chamber A; a second frame body 20 defining a cathode chamber C; an ion-permeable separating membrane 40 being arranged between the first frame body 10 and the second frame body 20, and separating the anode chamber A and the cathode chamber C; electrical insulating gaskets 30, 30 (hereinafter may be referred to as “gaskets 30”) sandwiched between and held by the first frame body 10 and the second frame body 20, and holding the periphery of the separating membrane 40; an anode 50 being arranged in the anode chamber A, and being electrically connected with a first separating wall 11; and a cathode 60 being arranged in the cathode chamber C, and being electrically connected with a second separating wall 21. The first frame body 10 comprises: the electroconductive first separating wall 11; and a first flange part 12 arranged at the outer periphery of the separating wall 11. The second frame body 20 also comprises: the electroconductive separating wall 21; and a second flange part 22 arranged at the outer periphery of the second separating wall 21. The separating walls 11 and 21 each separate and electrically connect adjacent electrolytic cells in series. The first flange part 12, together with the separating wall 11, the separating membrane 40 and one of the gaskets 30, defines the anode chamber A. The second flange part 22, together with the separating wall 21, the separating membrane 40 and the other gasket 30, defines the cathode chamber C.

The first frame body 10 further comprises at least one electroconductive supporting member (first supporting member) 13, 13, ... (hereinafter may be referred to as “supporting members 13”) to protrude from the separating wall 11. The anode 50 is held by the supporting members 13. The supporting members 13 are electrically connected with the first separating wall 11 and the anode 50. The second frame body 20 further comprises electroconductive supporting members (second supporting members) 23, 23, ... (hereinafter may be referred to as “supporting members 23”) to protrude from the separating wall 21. The cathode 60 is held by the supporting members 23. The supporting members 23 are electrically connected with the second separating wall 21 and the cathode 60. The first flange part 12 is provided with an anolyte supply flow path adapted to supply an anolyte to the anode chamber A, and an anolyte collection flow path adapted to collect, from the anode chamber A, the anolyte, and gas generated at the anode; and the second flange part 22 is provided with a catholyte supply flow path adapted to supply a catholyte to the cathode chamber C, and a catholyte collection flow path adapted to collect, from the cathode chamber C, the catholyte, and gas generated at the cathode, which are not shown in FIG. 1.

An alkali-resistant rigid electroconductive material may be used as the material of the first separating wall 11 and the second separating wall 21. For example, a simple metal such as nickel and iron; or a metallic material such as stainless steel including SUS304, SUS310, SUS310S, SUS316 and SUS316L may be preferably used. When any of the metallic materials is used, the metallic material may be nickeled in order to improve corrosion resistance and electroconductivity.

An alkali-resistant rigid material may be used as the material of the first flange part 12 and the second flange part 22. For example, a simple metal such as nickel and iron; a metallic material such as stainless steel including SUS304, SUS310, SUS310S SUS316 and SUS316L; or a non-metallic material such as reinforced plastics may be used. When any of the metallic materials among them is used, the metallic material may be nickeled in order to improve corrosion resistance.

The separating wall 11 and the flange part 12 of the first frame body 10 may be joined to each other by welding, adhesion, or the like, and may be formed of the same material into one body. Likewise, the separating wall 21 and the flange part 22 of the second frame body 20 may be joined to each other by welding, adhesion, or the like, and may be formed of the same material into one body. Because it is easy to improve the tolerance to the pressure inside the chambers, the separating wall 11 and the flange part 12 of the first frame body 10 are preferably formed of the same material into one body; and the separating wall 21 and the flange part 22 of the second frame body 20 are preferably formed of the same material into one body.

Supporting members that can be used as electroconductive ribs in an alkaline water electrolysis vessel may be used as the first supporting members 13 and the second supporting members 23. In the electrolysis vessel 100, the first supporting members 13 protrude from the separating wall 11 of the first frame body 10; and the second supporting members 23 protrude from the separating wall 21 of the second frame body 20. The connecting way, the shape, the number, and the arrangement of the first supporting members 13 are not particularly limited as long as the anode 50 can be fixed to and held with respect to the first frame body 10 by the first supporting members 13. The connecting way, the shape, the number, and the arrangement of the second supporting members 23 are not particularly limited either as long as the cathode 60 can be fixed to and held with respect to the second frame body 20 by the second supporting members 23.

As the material of the first supporting members 13 and the second supporting members 23, an alkali-resistant rigid electroconductive material may be used. For example, a simple metal such as nickel and iron, or a metallic material such as stainless steel including SUS304, SUS310, SUS310S, SUS316 and SUS316L may be preferably used. When any of the metallic materials is used, the metallic material may be nickeled in order to improve corrosion resistance and electroconductivity.

The first frame body 10 comprises: a nickel-plating layer 10b of no less than 40 µm in thickness which is arranged at least on a wet part (that is, a part in contact with the anolyte) of part of the surface of the first frame body which faces the anode chamber A (that is, the inner surface of the first frame body). The first frame body 10 comprising such a thick nickel-plating layer 10b on the wet part enables the corrosion resistance of the anode chamber to the oxygen gas atmosphere and in oxygen gas-saturated alkaline water to be increased to a level sufficient for long-term use at low cost. In view of further increasing the corrosion resistance of the anode chamber to the oxygen gas atmosphere and in oxygen gas-saturated alkaline water, the thickness of the nickel-plating layer 10b is more preferably no less than 50 µm.The upper limit of the thickness of the nickel-plating layer is not particularly limited, but can be preferably, for example, no more than 100 µm in view of cost. The nickel-plating layer 10b is arranged at least on the wet part of the first frame body 10, and may be arranged on the entire part of the surface which faces the anode chamber A, and may be arranged on the entire surface of the first frame body 10.

In one preferred embodiment, the first frame body 10 comprises: at least one steel core member 10a; and the nickel-plating member 10b arranged on the surface of the core member. The nickel-plating layer 10b is arranged at least on a wet part of the core member 10a, and may be arranged on the entire part of the surface of the core member 10a which faces the anode chamber, and may be arranged on the entire surface of the core member 10a. In the electrolysis vessel 100, the steel core member 10a includes a steel core member 11a constituting the separating wall 11, a steel core member 12a constituting the flange part 12, and steel core members 13a constituting the supporting members 13. The nickel-plating layer 10b includes a nickel-plating layer 11b arranged on the surface of the core member 11a (that is, the surface of the separating wall 11), a nickel-plating layer 12b arranged on the surface of the core member 12a (that is, the surface of the flange part 12), and nickel-plating layers 13b arranged on the surfaces of the core members 13a (that is, the surfaces of the supporting members 13).

In one embodiment, such a first frame body 10 can be manufactured by nickeling the steel core member 11a constituting the separating wall 11, and the steel core member 12a constituting the flange part 12. One may nickel a core member of one body including the steel core member 11a constituting the separating wall 11, and the steel core member 12a constituting the flange part 12; and one may each separately nickel, and join the steel core member 11a constituting the separating wall 11, and the steel core member 12a constituting the flange part 12 to each other. When the first frame body 10 comprises the supporting members 13, one may nickel a core member of one body including the steel core member 11a constituting the separating wall 11, and the steel core members 13a constituting the supporting members 13, and optionally further including the steel core member 12a constituting the flange part 12; and one may nickel the steel core members 13a constituting the supporting members 13, and thereafter, join the supporting members 13 comprising the core members 13a and the nickel-plating layers 13b to the separating wall 11. As described above, the first flange part 12 is provided with the anolyte supply flow path (not shown) adapted to supply the anolyte to the anode chamber A, and the anolyte collection flow path (not shown) adapted to collect, from the anode chamber A, the anolyte, and gas generated at the anode. When the flange part 12 comprises the steel core member 12a, preferably, the nickel-plating layer 12b is also arranged on the inner surfaces of the anolyte supply flow path and the anolyte collection flow path, which are provided for the flange part 12. The nickel-plating layer 12b is preferably arranged on at least wet parts of the inner surfaces of the anolyte supply flow path and the anolyte collection flow path, which are provided for the flange part 12, and may be arranged on the entire inner surfaces thereof.

In another embodiment, such a first frame body 10 can be manufactured by nickeling the steel core member 11a constituting the separating wall 11, and thereafter joining the separating wall 11 comprising the core member 11a and the nickel-plating layer 11b, and the flange part 12 made from a non-metallic material. When the first frame body 10 comprises the supporting members 13, one may nickel a core member of one body including the steel core member 11a constituting the separating wall 11, and the steel core members 13a constituting the supporting members 13; and one may each separately nickel, and join the steel core member 11a constituting the separating wall 11, and the steel core members 13a constituting the supporting members 13 to each other.

The second frame body 20 preferably comprises: a nickel-plating layer 20b being arranged at least on a wet part (that is, a part in contact with the catholyte) of part of the surface of the second frame body which faces the cathode chamber C (that is, the inner surface of the second frame body). The second frame body 20 comprising the nickel-plating layer 20b on the wet part enables the corrosion resistance of the cathode chamber in an alkaline condition to be increased to a sufficient level. The nickel-plating layer 20b has a thickness enough to bring corrosion resistance enough to stand the alkaline condition in the cathode chamber. The thickness is sufficient if 2 µm, as disclosed in Patent Literature 3, and is preferably no less than 10 µm. The upper limit of the thickness of the nickel-plating layer is not particularly limited, but can be preferably, for example, no more than 100 µm in view of cost. The nickel-plating layer 20b is arranged at least on the wet part of the second frame body 20, and may be arranged on the entire part of the surface which faces the cathode chamber C, and may be arranged on the entire surface of the second frame body 20.

In one preferred embodiment, the second frame body 20 comprises: at least one steel core member 20a; and the nickel-plating member 20b arranged on the surface of the core member. The nickel-plating layer 20b is arranged at least on a wet part of the core member 20a, and may be arranged on the entire part of the surface of the core member 20a which faces the anode chamber, and may be arranged on the entire surface of the core member 20a. In the electrolysis vessel 100, the steel core member 20a includes a steel core member 21a constituting the separating wall 21, a steel core member 22a constituting the flange part 22, and steel core members 23a constituting the supporting members 23. The nickel-plating layer 20b includes a nickel-plating layer 21b arranged on the surface of the core member 21a (that is, the surface of the separating wall 21), a nickel-plating layer 22b arranged on the surface of the core member 22a (that is, the surface of the flange part 22), and nickel-plating layers 23b arranged on the surfaces of the core members 23a (that is, the surfaces of the supporting members 23).

In one embodiment, such a second frame body 20 can be manufactured by nickeling the steel core member 21a constituting the separating wall 21, and the steel core member 22a constituting the flange part 22. One may nickel a core member of one body including the steel core member 21a constituting the separating wall 21, and the steel core member 22a constituting the flange part 22; and one may each separately nickel, and join the steel core member 21a constituting the separating wall 21, and the steel core member 22a constituting the flange part 22 to each other. When the second frame body 20 comprises the supporting members 23, one may nickel a core member of one body including the steel core member 21a constituting the separating wall 21, and the steel core members 23a constituting the supporting members 23, and optionally further including the steel core member 22a constituting the flange part 22; and one may nickel the steel core members 23a constituting the supporting members 23, and thereafter, join the supporting members 23 comprising the core members 23a and the nickel-plating layers 23b to the separating wall 21. As described above, the second flange part 22 is provided with the catholyte supply flow path (not shown) adapted to supply the catholyte to the cathode chamber C, and the catholyte collection flow path (not shown) adapted to collect, from the cathode chamber C, the catholyte, and gas generated at the cathode. When the flange part 22 comprises the steel core member 22a, preferably, the nickel-plating layer 22b is also arranged on the inner surfaces of the catholyte supply flow path and the catholyte collection flow path, which are provided for the flange part 22. The nickel-plating layer 22b is preferably arranged on at least wet parts of the inner surfaces of the catholyte supply flow path and the catholyte collection flow path, which are provided in the flange part 22, and may be arranged on the entire inner surfaces thereof.

In another embodiment, such a second frame body 20 can be manufactured by nickeling the steel core member 21a constituting the separating wall 21, and thereafter joining the separating wall 21 comprising the core member 21a and the nickel-plating layer 21b, and the flange part 22 made from a non-metallic material. When the second frame body 20 comprises the supporting members 23, one may nickel a core member of one body including the steel core member 21a constituting the separating wall 21, and the steel core members 23a constituting the supporting members 23; and one may each separately nickel, and join the steel core member 21a constituting the separating wall 21, and the steel core members 23a constituting the supporting members 23 to each other.

Any known nickeling method may be employed when the steel core members are each nickeled. The steel core members may be nickeled by electroplating, and may be nickeled by electroless-plating. Electroless nickel-plating can be preferably employed in view of forming a nickel-plating layer having a more uniform thickness even on a core material having a complex shape to increase durability, and in view of the strength of the plating film after plating. Electroless nickel-plating can be carried out by a known process. For example, an electroless nickel-plating layer can be formed on the surface of the steel core member by the steps of pickling, degreasing, electrolytic-degreasing, acid-activating, electroless nickel-plating depositing, and heat treatment after plating the steel core member, in the order mentioned. The phosphorus content in the electroless nickel-plating layer is preferably 1 to 12 mass% in view of improving corrosion resistance in an alkaline condition.

Any electrical insulating gaskets that can be used for an electrolysis vessel for alkaline water electrolysis may be used as the gaskets 30 without particular limitations. FIG. 1 shows a cross section of the gaskets 30. Each of the gaskets 30 has a flat shape. The periphery of the separating membrane 40 is sandwiched between and held by the gaskets 30, and at the same time the gaskets 30 are sandwiched between and held by the first flange part 12 and the second flange part 22. The gaskets 30 are preferably formed of an alkali-resistant elastomer. Examples of the material of the gaskets 30 include elastomers such as natural rubber (NR), styrene-butadiene rubber (SBR), polychloroprene (CR), butadiene rubber (BR), acrylonitrile-butadiene rubber (NBR), silicone rubber (SR), ethylene propylene rubber (EPT), ethylene propylene diene monomer rubber (EPDM), fluororubber (FR), isobutylene isoprene rubber (IIR), urethane rubber (UR), and chlorosulfonated polyethylene rubber (CSM). When a gasket material that is not alkali-resistant is used, a layer of an alkali-resistant material may be provided over the surface of the gasket material by coating or the like.

An ion-permeable separating membrane that can be used for an electrolysis vessel for alkaline water electrolysis may be used as the separating membrane 40 without particular limitations. The separating membrane 40 desirably has low gas permeability, low electric conductivity, and high strength. Examples of the separating membrane 40 include porous separating membranes such as a porous membrane formed of asbestos or modified asbestos, a porous separating membrane using a polysulfone-based polymer, a cloth using a polyphenylene sulfide fiber, a fluorinated porous membrane, and a porous membrane using a hybrid material including both inorganic and organic materials. Other than these porous separating membranes, an ion-exchange membrane such as a fluorinated ion-exchange membrane may be used as the separating membrane 40.

Any anode that can be used for an electrolysis vessel for alkaline water electrolysis may be used as the anode 50 without particular limitations. The anode 50 usually includes an electroconductive base material, and a catalyst layer covering the surface of the base material. The catalyst layer is preferably porous. As the electroconductive base material of the anode 50, for example, nickel, a nickel alloy, ferronickel, vanadium, molybdenum, copper, silver, manganese, a platinum group metal, graphite, or chromium, or any combination thereof may be used. In the anode 50, an electroconductive base material formed of nickel may be preferably used. The catalyst layer includes nickel as an element. The catalyst layer preferably includes nickel oxide, metallic nickel or nickel hydroxide, or any combination thereof, and may include an alloy of nickel and at least another metal. The catalyst layer is especially preferably formed of metallic nickel. The catalyst layer may further include chromium, molybdenum, cobalt, tantalum, zirconium, aluminum, zinc, a platinum group metal, or a rare earth element, or any combination thereof. Rhodium, palladium, iridium, or ruthenium, or any combination thereof may be further supported on the surface of the catalyst layer as an additional catalyst. The electroconductive base material of the anode 50 may be a rigid base material, and may be a flexible base material. Examples of the rigid electroconductive base material forming the anode 50 include expanded metals and punching metals. An example of the flexible electroconductive base material forming the anode 50 is a wire net woven (or knitted) out of metal wire.

Any cathode that can be used for an electrolysis vessel for alkaline water electrolysis may be used as the cathode 60 without particular limitations. The cathode 60 usually includes an electroconductive base material, and a catalyst layer covering the surface of the base material. As the electroconductive base material of the cathode 60, for example, nickel, a nickel alloy, stainless steel, mild steel, a nickel alloy, nickeled stainless steel, or nickeled mild steel may be preferably employed. As the catalyst layer of the cathode 60, a catalyst layer formed of a noble metal oxide, nickel, cobalt, molybdenum, or manganese, or an oxide or a noble metal oxide thereof may be preferably used. The electroconductive base material forming the cathode 60 may be, for example, a rigid base material, and may be a flexible base material. Examples of the rigid electroconductive base material forming the cathode 60 include expanded metals and punching metals. An example of the flexible electroconductive base material forming the cathode 60 is a wire net woven (or knitted) out of metal wire.

According to the electrolysis vessel 100, the nickel-plating layer 10b of no less than 40 µm in thickness is arranged at least on the wet part of part of the surface of the first frame body 10 which faces the anode chamber A, which enables the corrosion resistance of the anode chamber to the oxygen gas atmosphere and in oxygen gas-saturated alkaline water to be increased to a level sufficient for long-term use at low cost.

The electrolysis vessel 100 including gaps between the anode 50 and the separating membrane 40, and between the cathode 60 and the separating membrane 40 has been described above concerning the present invention as an example. The present invention is not limited to this embodiment. For example, the electrolysis vessel can be a so-called zero-gap alkaline water electrolysis vessel comprising a flexible cathode in the cathode chamber instead of the rigid cathode 60, a cathode current collector held by the supporting members 23, an electroconductive elastic body arranged between the cathode current collector and the separating membrane 40 and supported by the cathode current collector, and the flexible cathode arranged between the elastic body and the separating membrane 40, wherein the elastic body pushes the flexible cathode toward the separating membrane 40 and the anode 50, and thereby, the flexible cathode and the separating membrane 40 are in direct contact with each other, and the separating membrane 40 and the anode 50 are in direct contact with each other.

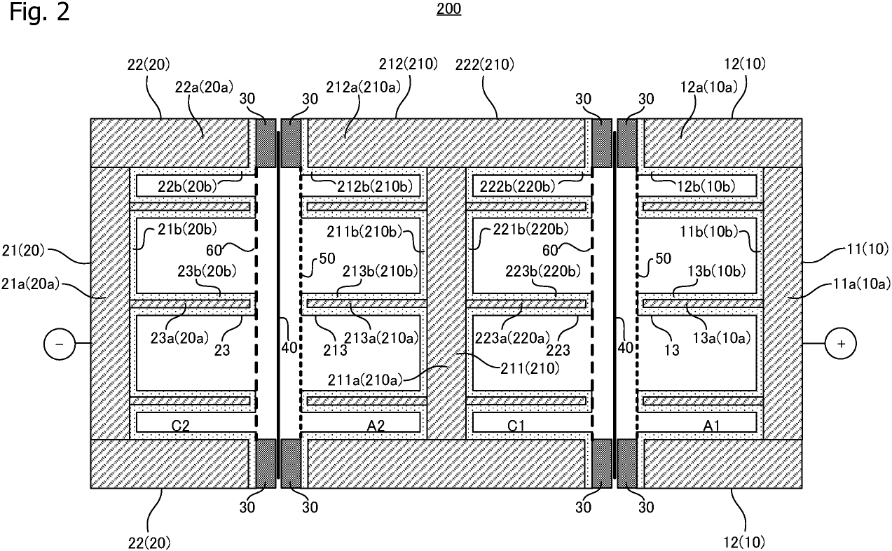

The electrolysis vessel 100 comprising a single cell has been described above concerning the present invention as an example. The present invention is not limited to this embodiment. For example, the electrolysis vessel may comprise a plurality of electrolytic cells connected in series and each comprise a pair of the anode chamber A defined by the first frame body 10, and the cathode chamber C defined by the second frame body 20. For example, the flange part 12 of the first frame body 10 may extend to the opposite side of the separating wall 11 (right side of the sheet of FIG. 2) to further define, together with the separating wall 11, a cathode chamber of the neighboring electrolytic cell; and the flange part 12 of the second frame body 20 may extend to the opposite side of the separating wall 12 (left side of the sheet of FIG. 2) to further define, together with the separating wall 21, an anode chamber of the neighboring electrolytic cell. FIG. 2 schematically illustrates an alkaline water electrolysis vessel 200 according to such another embodiment (hereinafter may be referred to as “electrolysis vessel 200”). In FIG. 2, the elements already shown in FIG. 1 are given the same reference signs as in FIG. 1, and the description thereof may be omitted. The electrolysis vessel 200 is an alkaline water electrolysis vessel having the structure of connecting an electrolytic cell comprising an anode chamber A1 and a cathode chamber C1, and an electrolytic cell comprising an anode chamber A2 and a cathode chamber C2 in series. The electrolysis vessel 200 comprises the first frame body 10 connected to an anode terminal, and defines the anode chamber A1; the second frame body 20 connected to a cathode terminal, and defines the cathode chamber C2; at least one third frame body 210 arranged between the first frame body 10 and the second frame body 20; plurality of the gaskets 30 provided for each frame body; the separating membranes 40; the anodes 50; and the cathodes 60. The separating membranes 40 are respectively arranged between the first frame body 10 and the third frame body 210 adjacent to the first frame body 10, between the second frame body 20 and the third frame body 210 adjacent to the second frame body 20, and between every two adjacent third frame bodies 210 when a plurality of the third frame bodies 210 are present; and are each sandwiched and held by the gaskets 30. The first frame body 10 and the third frame body 210 define the anode chamber A1 and the cathode chamber C1; and the third frame body 210 and the second frame body 20 define the anode chamber A2 and the cathode chamber C2. The anodes 50 are arranged in the anode chambers A1 and A2, respectively; and the cathodes 60 are arranged in the cathode chambers C1 and C2, respectively.

The first frame body 10 and the second frame body 20 have the same structure as the first frame body 10 and the second frame body 20 in the above-described electrolysis vessel 100 (FIG. 1), respectively. The separating wall 11 of the first frame body 10 is connected to the anode terminal; and the separating wall 21 of the second frame body 20 is connected to the cathode terminal. In the anode chamber A1 defined by the first frame body 10, the anode 50 is held by the supporting members 13; and in the cathode chamber C2 defined by the second frame body 20, the cathode 60 is held by the supporting members 23, which are also as described above.

The third frame body 210 is a bipolar electrolysis element having the structure of one body including the first frame body 10 and the second frame body 20. That is, the third frame body 210 comprises an electroconductive separating wall 211, a first flange part 212 extending from the outer periphery of the separating wall 211 to the second frame body 20 side (left side of the sheet of FIG. 2), and a second flange part 222 extending from the outer periphery of the separating wall 211 to the first frame body 10 side (right side of the sheet of FIG. 2). In the third frame body 210, the first flange part 212 and the second flange part 222 are formed into one body. In the third frame body 210, on the first frame body 10 side of the separating wall 211 (right side of the sheet of FIG. 2), electroconductive supporting members (second supporting members) 223 are provided so as to protrude from the separating wall 211. The cathode 60 is held by the supporting members 223 in the cathode chamber C1, and the supporting members 223 are electrically connected with the cathode 60 arranged in the cathode chamber C1, and the separating wall 211. In the third frame body 210, on the second frame body 20 side of the separating wall 211 (left side of the sheet of FIG. 2), electroconductive supporting members (first supporting members) 213 are provided so as to protrude from the separating wall 211. The anode 50 is held by the supporting members 213 in the anode chamber A2, and the supporting members 213 are electrically connected with the anode 50 arranged in the anode chamber A2, and the separating wall 211 of the third frame body 210. The structures of the separating wall 211, the first supporting members 213 and the second supporting members 223 are the same as the separating wall 11, the first supporting members 13 and the second supporting member 23 described above concerning the electrolysis vessel 100 (FIG. 1), respectively. The structures of the first flange part 212 and the second flange part 222 are the same as the first flange part 12 and the second flange part 22 described above concerning the electrolysis vessel 100 (FIG. 1), respectively, except that the first flange part 212 and the second flange part 222 are formed into one body.

The third frame body 210 comprises: a nickel-plating layer 210b of no less than 40 µm in thickness which is arranged at least on a wet part (that is, a part in contact with the anolyte) of part of the surface of the third frame body which faces the anode chamber A2 (that is, the inner surface of the third frame body). The third frame body 210 comprising such a thick nickel-plating layer 210b on the wet part of the anode chamber enables the corrosion resistance of the anode chamber to the oxygen gas atmosphere and in oxygen gas-saturated alkaline water to be increased to a level sufficient for long-term use. In view of further increasing the corrosion resistance of the anode chamber to the oxygen gas atmosphere and in oxygen gas-saturated alkaline water, the thickness of the nickel-plating layer 210b is more preferably no less than 50 µm. The upper limit of the thickness of the nickel-plating layer is not particularly limited, but can be preferably, for example, no more than 100 µm in view of cost. The nickel-plating layer 210b is arranged at least on the wet part of part of the surface of the third frame body 210 which faces the anode chamber A2, and may be arranged on the entire part of the surface which faces the anode chamber A2, and may be arranged on the entire surface of the third frame body 210 (that is, continuously with a nickel-plating layer 220b described later).

In one preferred embodiment, the third frame body 210 comprises: at least one steel core member 210a; and the nickel-plating member 210b arranged on the surface of the core member. The nickel-plating layer 210b is arranged at least on a wet part of the core member 210a, and may be arranged on the entire part of the surface of the core member 210a which faces the anode chamber, and may be arranged on the entire surface of the core member 210a.

The third frame body 210 preferably comprises: the nickel-plating layer 220b being arranged at least on a wet part (that is, a part in contact with the catholyte) of part of the surface of the third frame body which faces the cathode chamber C1. The third frame body 210 comprising the nickel-plating layer 220b on the wet part of the cathode chamber enables the corrosion resistance of the cathode chamber in an alkaline condition to be increased to a sufficient level. In view of further increasing the corrosion resistance of the cathode chamber in an alkaline condition, the thickness of the nickel-plating layer 220b is preferably no less than 2 µm, and may be no less than 10 µm. The upper limit of the thickness of the nickel-plating layer is not particularly limited, but can be preferably, for example, no more than 100 µm in view of cost. The nickel-plating layer 220b is arranged at least on the wet part of part of the surface of the third frame body 210 which faces the cathode chamber, and may be arranged on the entire part of the surface which faces the cathode chamber, and may be provided continuously with the nickel-plating layer 210b.

In one preferred embodiment, the third frame body 210 comprises: at least one steel core member 210a; and the nickel-plating members 210b and 220b arranged on the surface of the core member. The nickel-plating layer 220b is arranged at least on the wet part of part of the surface of the core member 210a which faces the cathode chamber C1, and may be arranged on the entire part of the surface of the core member 210a which faces the cathode chamber C1, and may be arranged continuously with the nickel-plating layer 210b. In view of reducing energy loss, the nickel-plating layer 220b is preferably provided continuously with the nickel-plating layer 210b. In the third frame body 210, the steel core member 210a includes a steel core member 211a constituting the separating wall 211, a steel core member 212a constituting the first flange part 212 and the second flange part 222, and steel core members 213a and 223a constituting the first supporting members 213 and the second supporting members 223, respectively. The nickel-plating layer 210b includes a nickel-plating layer 211b arranged on part of the surface of the core member 211a which faces the anode chamber A2 (that is, part of the surface of the separating wall 211 which faces the anode chamber A2), a nickel-plating layer 212b arranged on part of the surface of the core member 212a which faces the anode chamber A2 (that is, the surface of the first flange part 212), and nickel-plating layers 213b arranged on the surfaces of the core members 213a (that is, the surfaces of the first supporting members 213). The nickel-plating layer 220b includes a nickel-plating layer 221b arranged on part of the surface of the core member 211a which faces the cathode chamber C1 (that is, part of the surface of the separating wall 211 which faces the cathode chamber C1), a nickel-plating layer 222b arranged on part of the surface of the core member 212a which faces the cathode chamber C1 (that is, the surface of the second flange part 222), and nickel-plating layers 223b arranged on the surfaces of the core members 223a (that is, the surfaces of the second supporting members 223).

In one embodiment, such a third frame body 210 can be manufactured by nickeling the steel core member 211a constituting the separating wall 211, and the steel core member 212a constituting the flange parts 212 and 222. One may nickel a core member of one body including the steel core member 211a constituting the separating wall 211, and the steel core member 212a constituting the flange parts 212 and 222; and one may each separately nickel, and join the steel core member 211a constituting the separating wall 211, and the steel core member 212a constituting the flange parts 212 and 222 to each other. When the third frame body 210 comprises the supporting members 213 and 223, one may nickel a core member of one body including the steel core member 211a constituting the separating wall 211, and the steel core members 213a and 223a constituting the supporting members 213 and 223, and optionally further including the steel core member 212a constituting the flange parts 212 and 222; and one may nickel the steel core members 213a and 223a constituting the supporting members 213 and 223, and thereafter, join, to the separating wall 211, the first supporting members 213 comprising the core members 213a and the nickel-plating layers 213b, and the second supporting members 223 comprising the core members 223a and the nickel-plating layers 223b.

In another embodiment, such a third frame body 210 can be manufactured by nickeling the steel core member 211a constituting the separating wall 211, and thereafter joining the separating wall 211 comprising the core member 221a and the nickel-plating layer 211b, and the flange parts 212 and 222 made from a non-metallic material. When the third frame body 210 comprises the supporting members 213 and 223, one may nickel a core member of one body including the steel core member 211a constituting the separating wall 211, and the steel core members 213a and 223a constituting the supporting members 213 and 223; and one may each separately nickel, and join the steel core member 211a constituting the separating wall 211, and the steel core members 213a and 223a constituting the supporting members 213 and 223 to each other.

In the third frame body 210, the flange parts 212 and 222 are provided with an anolyte supply flow path adapted to supply the anolyte to the anode chamber A2, an anolyte collection flow path adapted to collect, from the anode chamber A2, the anolyte, and gas generated at the anode, a catholyte supply flow path adapted to supply the catholyte to the cathode chamber C1, and a catholyte collection flow path adapted to collect, from the cathode chamber C1, the catholyte, and gas generated at the cathode, which are not shown in FIG. 2. It is noted that the anolyte supply flow path or the anolyte collection flow path are not connected to the cathode chamber C1, and there is no flow of the electrolyte or gas therebetween. It is also noted that the catholyte supply flow path or the catholyte collection flow path are not connected to the anode chamber A2, and there is no flow of the electrolyte or gas therebetween. When the flange parts 212 and 222 comprise the steel core member 212a, the nickel-plating layers 212b and 222b are also provided over the inner surfaces of the anolyte supply flow path and the anolyte collection flow path, and the catholyte supply flow path and the catholyte collection flow path provided in the flange parts 212 and 222. The nickel-plating layers 212b and 222b are preferably arranged on at least wet parts of the inner surfaces of the anolyte supply flow path and the anolyte collection flow path, and the catholyte supply flow path and the catholyte collection flow path provided in the flange parts 212 and 222, and may be arranged on the entire inner surfaces thereof.

According to the electrolysis vessel 200, the nickel-plating layer 10b of no less than 40 µm in thickness is arranged at least on the wet part of part of the surface of the first frame body 10 which faces the anode chamber A1, and the nickel-plating layer 210b of no less than 40 µm in thickness is arranged at least on the wet part of part of the surface of the third frame body 210 which faces the anode chamber A2, which enable the corrosion resistance of the anode chamber to the oxygen gas atmosphere and in oxygen gas-saturated alkaline water to be increased to a level sufficient for long-term use at low cost.

### REFERENCE SIGNS LIST

10 first frame body
20 second frame body
210 third frame body
10a, 20a, 210a (steel) core member
10b, 20b, 210b, 220b nickel-plating layer
11, 21, 211 (electroconductive) separating wall
12, 212 first flange part
22, 222 second flange part
13, 213, 23, 223 (electroconductive) supporting member
30 gasket
40 (ion-permeable) separating membrane
50 anode
60 cathode
100, 200 electrolysis vessel
A, A1, A2 anode chamber
C, C1, C2 cathode chamber

1. An alkaline water electrolysis vessel comprising:
a first frame body defining an anode chamber,
the first frame body comprising:
an electroconductive first separating wall; and
a first flange part arranged at an outer periphery of the first separating wall;
a second frame body defining a cathode chamber,
the second frame body comprising:
an electroconductive second separating wall; and
a second flange part arranged at an outer periphery of the second separating wall;
an ion-permeable separating membrane being arranged between the first frame body and the second frame body, and separating the anode chamber and the cathode chamber;
an anode being arranged in the anode chamber, and being electrically connected with the first separating wall; and
a cathode being arranged in the cathode chamber, and being electrically connected with the second separating wall,
the first frame body further comprising:
a nickel-plating layer of no less than 40 µm in thickness, the nickel-plating layer being arranged at least on a wet part of a first surface of the first frame body, the first surface facing the anode chamber.

2. The electrolysis vessel according to claim 1,
the first frame body further comprising:
an electroconductive supporting member protruding from the first separating wall into the anode chamber, and supporting the anode.

3. The electrolysis vessel according to claim 1,
the first frame body comprising:
at least one steel core member; and
the nickel-plating member arranged on a surface of the core member.

4. The electrolysis vessel according to claim 1,
wherein the nickel-plating layer has a thickness of 50 to 100 µm.
